(19) United States
(12) Patent Application Publication
(10) Pub. No.: US 2022/0408646 A1
(43) Pub. Date: Dec. 29, 2022

(54) Method and Control Unit for Operating an Agricultural Harvester, and Agricultural Harvester

(71) Applicant: CLAAS Saulgau GmbH, Bad Saulgau (DE)

(72) Inventors: Christian König, Oberteuringen (DE); Manfred Pollklas, Rheda-Wiedenbrück (DE); Stefan Rothmund, Hohentengen (DE); Hubert Maucher, Bad Wurzach (DE); Florian Wälder, Sigmaringendorf (DE); Siegfried Gernert, Bad Waldsee-Mittelurbach (DE); Christoph Kaufmann, Hohentengen (DE)

(21) Appl. No.: 17/845,795

(22) Filed: Jun. 21, 2022

(30) Foreign Application Priority Data
Jun. 29, 2021 (DE) 102021116753.1

(51) Int. Cl. A01D 43/08

(52) U.S. Cl. CPC A01D 43/082

(57) ABSTRACT

Method for operating an agricultural harvester (1), wherein the agricultural harvester (1) has an attachment (2), wherein the attachment (2) has a receiving conveyor (7) which is driven at a defined first speed, wherein the attachment (2) has a discharge conveyor (8) which is driven at a defined second speed, wherein the harvester (1) has an infeed unit (4) with infeed rollers (5, 6) which are driven at a defined third speed. The second speed, at which the discharge conveyor (8) is driven, is determined depending on the third speed, at which the infeed rollers (5, 6) are driven, and also depending on the speed of travel of the agricultural harvester (1).

The invention relates to a method and a control unit for operating an agricultural harvester, and to an agricultural harvester.

EP 2 281 434 B1 discloses an agricultural harvester having an attachment. The attachment has a receiving conveyor, which is referred to as a pickup device. The attachment also has a discharge conveyor, which is referred to as a cross-conveyor device. The harvester has an infeed unit with infeed rollers.

It is known that, during operation of the agricultural harvesters, the receiving conveyor is driven at a first speed, the discharge conveyor is driven at a second speed and the infeed rollers are driven at a third speed.

EP 1 609 351 B1 discloses a further agricultural harvester having an attachment. Here too, the attachment has a receiving conveyor and a discharge conveyor, and the harvester has an infeed unit with infeed rollers. The receiving conveyor is driven at a first speed, the discharge conveyor at a second speed and the infeed rollers at a third speed. According to EP 1 609 351 B1, the second speed, at which the discharge conveyor is driven, is dependent on the first speed, at which the receiving conveyor is driven, and on the third speed, at which the infeed rollers are driven.

It is important to ensure, during operation, an optimal flow of material from the receiving conveyor via the discharge conveyor in the direction of the infeed unit. This has not previously been possible in all operating situations of the agricultural harvester.

Against this background, the present invention is based on the object of creating a novel method and control unit for operating an agricultural harvester, and an agricultural harvester having such a control system.

This object is achieved by a method for operating an agricultural harvester according to claim 1.

According to the invention, the second speed, at which the discharge conveyor is driven, is determined depending on the third speed, at which the infeed rollers are driven, and also depending on the speed of travel of the agricultural harvester.

Preferably, the first speed, at which the receiving conveyor is driven, is determined depending on a speed of travel of the agricultural harvester.

The second speed, at which the discharge conveyor is driven, is determined both depending on the speed at which the infeed rollers are driven and depending on the speed of travel of the agricultural harvester.

Thus, under all operating conditions, specifically at all possible speeds of travel of the harvester, an optimal flow of material from the receiving conveyor via the discharge conveyor in the direction of the infeed unit can be ensured.

Preferably, the greater the third speed, at which the infeed rollers are driven, the greater the second speed, at which the discharge conveyor is driven. Furthermore, the greater the speed of travel of the agricultural harvester, the greater the second speed, at which the discharge conveyor is driven. This is particularly preferred for an optimal flow of material.

Preferably, the second speed, at which the discharge conveyor is driven, is determined via a function or characteristic dependent on the third speed, wherein an offset value, in particular a stepless offset value, is overlaid on the function or characteristic depending on the speed of travel of the agricultural harvester. These details are also preferred in order to ensure an optimal flow of material from the receiving conveyor via the discharge conveyor in the direction of the infeed unit at all speeds of travel of the agricultural harvester.

The control unit is defined in claim 7 and the agricultural harvester is defined in claim 9.

Preferred developments of the invention can be gathered from the dependent claims and the following description.

Exemplary embodiments of the invention are explained in more detail, without being limited thereto, on the basis of the drawing, in which:

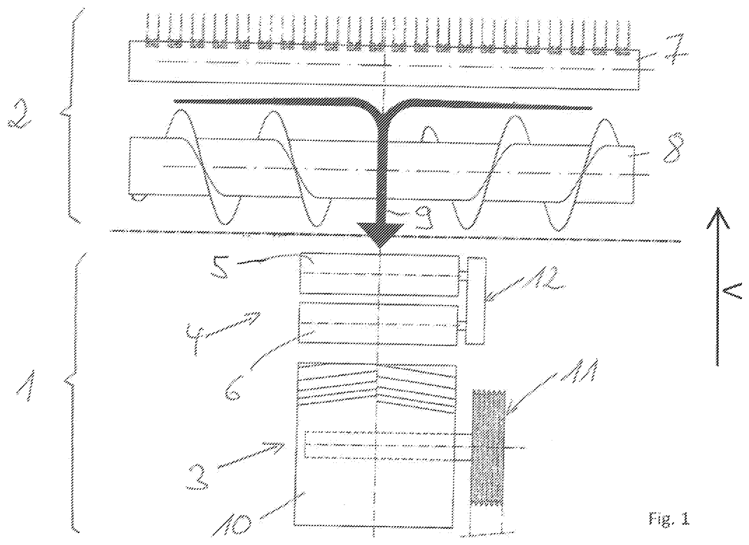

FIG. 1 shows a detail of an agricultural harvester;

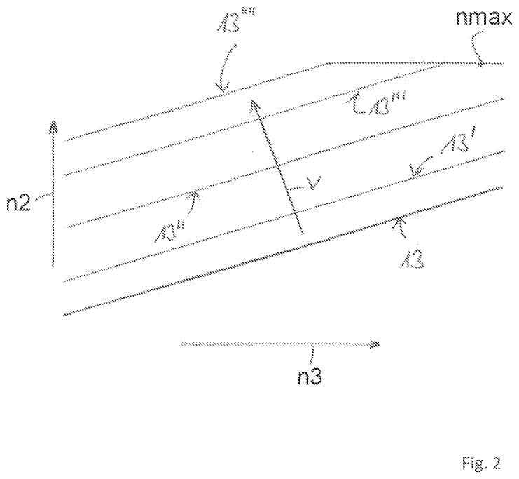

FIG. 2 shows a diagram for explaining the invention.

FIG. 1 shows a detail of an agricultural harvester 1 which carries an attachment 2.

In the exemplary embodiment shown, the agricultural harvester 1 is a forage harvester, which has a chopping unit 3 and an infeed unit 4 mounted upstream of the chopping unit 3 as seen in the direction of material flow. Of the infeed unit 4, infeed rollers 5, 6 are shown.

The attachment 2 has a receiving conveyor 7 and a discharge conveyor 8.

In the exemplary embodiment shown, the receiving conveyor 7 is a pickup device, the discharge conveyor 8 is a cross-conveyor device, namely a screw conveyor—sometimes also referred to as a cross-conveyor screw.

Via the receiving conveyor 7, crop can be picked up off the ground and fed to the discharge conveyor 8, which conveys the crop to the middle and feeds them to the infeed unit 4. The direction of flow of the crop in the region of the attachment 2 and the transfer of the crop from the attachment 2 in the direction of the infeed unit 4 is illustrated by an arrow 9 in FIG. 1.

During operation, the chopping unit 3, namely a chopping drum 10 thereof, is driven via a belt drive 11 at a defined—preferably approximately constant—speed. Furthermore, the infeed rollers 5, 6 of the infeed unit 4 are driven at a defined speed, wherein the infeed rollers 5, 6 are coupled via a transmission 12 and cooperate with further infeed rollers—not illustrated—in a generally known way. Furthermore, the receiving conveyor 7 and discharge conveyor 8 of the attachment 2 driven at a defined speed during operation of the agricultural harvester.

That speed at which the receiving conveyor 7 of the attachment 2 is operated is referred to as the first speed. That speed at which the discharge conveyor 8 of the attachment 2 is operated is referred to as the second speed. That speed at which the infeed rollers 5, 6 of the infeed unit 4 are driven is referred to as the third speed.

The faster the infeed rollers 5, 6 are driven, the greater the cutting length in the chopping unit 3. By contrast, the slower the infeed rollers 5, 6 are driven, the shorter the cutting length in the chopping unit 3.

In order now to ensure an optimal flow of material from the receiving conveyor 7 of the attachment 2 via the discharge conveyor 8 of the attachment 2 in the direction of the chopping unit 3 via the infeed unit 4, the invention provides that the first speed, at which the receiving conveyor 7 of the attachment 2 is driven, is determined depending on a speed of travel of the agricultural harvester 1.

The greater the speed of travel of the agricultural harvester, the greater the first speed, at which the receiving conveyor 7 is driven. This allows an optimal reception of crop via the receiving conveyor 7 for all speeds of travel.

The invention also provides for the second speed, at which the discharge conveyor 8 is driven, to be determined both depending on the third speed, at which the infeed rollers 5, 6 are driven, and depending on the speed of travel of the agricultural harvester 1.

In this case, the greater the third speed, at which the infeed rollers are driven, the greater the second speed, at which the discharge conveyor 8 is driven. Furthermore, the greater the speed of travel of the agricultural harvester 1, the greater the second speed, at which the discharge conveyor 8 of the attachment 2 is driven.

Using the invention, a uniform, optimal flow of material can be ensured in the attachment 2 and during the transfer from the attachment 2 to the harvester 1. This takes place fully automatically. The risk of blockages in the flow of material is reduced.

The second speed, at which the discharge conveyor 8 is driven, is determined via a function or characteristic 13 dependent on the third speed, at which the infeed rollers 5, 6 are driven. In this case, an offset value, in particular a stepless or continuously variable offset value, is overlaid on this function or characteristic 13 depending on the speed of travel of the agricultural harvester 1. The offset value is in this case dependent on the speed of travel of the agricultural harvester.

FIG. 2 depicts, by way of a diagram, the procedure for determining the second speed, at which the discharge conveyor 8 is driven. In FIG. 2, the third speed n3, at which the infeed rollers 5, 6 of the infeed unit 4 are driven, is plotted on the X-axis. The speed n2 at which the discharge conveyor 8 is driven is plotted on the Y-axis. A characteristic 13 reveals, in FIG. 2, the dependence of the second speed n2, at which the discharge conveyor 8 is driven, on the third speed n3, at which the infeed rollers 5, 6 are driven.

In the example in FIG. 2, there is linear dependence between the second speed n2 and the third speed n3, wherein the greater the third speed n3, the greater the second speed n2.

FIG. 2 illustrates that, depending on the speed of travel V of the agricultural harvester, an offset value is overlaid on this characteristic 13. In FIG. 2, the characteristic 13, which is valid for a stationary agricultural harvester 1, is shifted in parallel as the speed of travel V increases, specifically such that the second speed n2 becomes greater with an increasing speed of travel V of the agricultural harvester 1.

Thus, in addition to the characteristic 13 for a stationary agricultural harvester, FIG. 2 shows characteristics 13′, 13″, 13′″ and 13″″ shifted in parallel, wherein the characteristic 13′ is valid for example for a vehicle speed of 7 km/h, the characteristic 13″ is valid for example for a vehicle speed of 10 km/h, the characteristic 13′″ is valid for example for a vehicle speed of 13 km/h and the characteristic 13″″ is valid for example for a vehicle speed of 15 km/h of the agricultural harvester 1.

The offset value, which is therefore overlaid on the characteristic 13, is dependent on the speed of travel V of the agricultural harvester.

The offset value is in this case overlaid preferably in a stepless manner, i.e. preferably does not increase the speed n2 in discrete steps, but continuously as the speed of travel increases. However, it is alternatively also possible to keep different offset values for different speed levels.

It can be gathered from FIG. 2 that the second speed n2 for the discharge conveyor 8 is limited by a maximum value nmax.

Accordingly, in the context of the present invention, the second speed n2, at which the discharge conveyor 8 is driven, is determined both depending on the third speed n3, at which the infeed rollers 5, 6 of the infeed unit 4 are driven and depending on the speed of travel V of the agricultural harvester 1.

This can take place in steps or preferably in a stepless manner.

In this case, the increase in the second speed n2 depending on the speed of travel V can take place linearly or non-linearly.

The above-described method takes place fully automatically and is preferably carried out fully automatically by an electronic control unit of the agricultural harvester. However, it is also possible to provide for manual fine adjustment of the second speed n2, at which the discharge conveyor 8 of the attachment 2 is operated. In this case, the driver has the option of correcting the calculated speed value upwardly or downwardly via manual input.

The invention allows fully automatic harvesting operation at all speeds of travel of the agricultural harvester in conjunction with the different speeds n3 of the infeed rollers 5, 6, which determine the particular cutting length, without manual engagement. An optimal, homogeneous flow of material from the attachment 2 into the agricultural harvester 1 is allowed. The risk of blockages and wear is reduced.

The invention also relates to a control unit which is designed to carry out the above-described method automatically. Thus, the control unit determines the first speed, at which the receiving conveyor 7 is driven, depending on the speed of travel of the agricultural harvester. Furthermore, the control unit determines the second speed, at which the discharge conveyor 8 is driven, depending on the third speed, at which the infeed rollers 5, 6 are driven, and also depending on the speed of travel of the agricultural harvester 1.

Furthermore, the invention relates to an agricultural harvester having a control unit according to the invention. The agricultural harvester is in particular a forage harvester, which carries a maize header, a pickup or a mower as attachment.

The mower, which is usually referred to as a direct cutting unit, a mowing or cutting device severs the crop close to the ground, picks it up as a receiving conveyor from the ground and passes it to the discharge conveyor, which is usually in the form of a cross-conveyor screw. The cross-conveyor screw, or the discharge conveyor, conveys the crop to the middle of the machine and transfers it to the infeed unit 4. The mowing or cutting device is preferably embodied in the form of a plurality of mowing disks arranged alongside one another.

In a well-known maize header as attachment, rotating mowing and infeed disks sever plants, for example maize stalks, from the ground, convey these initially to the side and the rear, where they are conveyed to the middle of the maize header. The mowing and infeed disks should be considered, in the context of the current invention, to be receiving conveyors 7. In the transfer region to the harvester, so-called feeding drums are located, in a well-known way, to the left and right of the middle, and feed the plants to the infeed unit 4 of the harvester, in particular a forage harvester, and thus act as discharge conveyors 8.

### LIST OF REFERENCE SIGNS

1 Agricultural harvester
2 Attachment
3 Chopping unit
4 Infeed unit
5 Infeed roller
6 Infeed roller
7 Receiving conveyor
8 Discharge conveyor
9 Flow of material
10 Chopping drum
11 Belt drive
12 Transmission
13 Characteristic
13′ Characteristic
13″ Characteristic
13′″ Characteristic
13″″ Characteristic
V Speed of travel

1. A method for operating an agricultural harvester (1),
wherein the agricultural harvester (1) has an attachment (2),
wherein the attachment (2) has a receiving conveyor (7) which is driven at a defined first speed,
wherein the attachment (2) has a discharge conveyor (8) which is driven at a defined second speed,
wherein the harvester (1) has an infeed unit (4) with infeed rollers (5, 6) which are driven at a defined third speed,
characterized in that
the second speed, at which the discharge conveyor (8) is driven, is determined depending on the third speed, at which the infeed rollers (5, 6) are driven, and also depending on the speed of travel of the agricultural harvester (1).

2. The method according to claim 1, characterized in that
the greater the third speed, at which the infeed rollers (5, 6) are driven, the greater the second speed, at which the discharge conveyor (8) is driven, and
the greater the speed of travel of the agricultural harvester (1), the greater the second speed, at which the discharge conveyor (8) is driven.

3. The method according to claim 1, characterized in that
the second speed, at which the discharge conveyor (8) is driven, is determined via a function or characteristic (13) dependent on the third speed, wherein an offset value is overlaid on the function or characteristic (13) depending on the speed of travel of the agricultural harvester (1).

4. The method according to claim 3, characterized in that an offset value dependent on the speed of travel of the agricultural harvester is overlaid on the function or characteristic (13).

5. The method according to claim 3, characterized in that a stepless offset value is overlaid on the function or characteristic (13).

6. The method according to claim 1, characterized in that the second speed, at which the discharge conveyor (8) is driven, is limited by a maximum value.

7. A control unit for an agricultural harvester (1),
wherein the agricultural harvester (1) has an attachment (2),
wherein the attachment (2) has a receiving conveyor (7) which is driven at a defined first speed,
wherein the attachment (2) has a discharge conveyor (8) which is driven at a defined second speed,
wherein the harvester has an infeed unit (4) with infeed rollers (5, 6) which are driven at a defined third speed,
characterized in that
the control unit determines the second speed, at which the discharge conveyor (8) is driven, depending on the third speed, at which the infeed rollers (5, 6) are driven, and also depending on the speed of travel of the agricultural harvester (1).

8. The control unit according to claim 7, characterized in that the control unit is designed to carry out the method according to one of claims 1 to 6 automatically.

9. An agricultural harvester (1) having an attachment (2) and having a control unit according to claim 7.

10. The agricultural harvester (1) according to claim 9, wherein the attachment (2) is in the form of a maize header, of a pickup or of a mower or direct cutting unit, and the agricultural harvester (1) is in the form of a forage harvester.
